(19) United States
(12) Patent Application Publication
(10) Pub. No.: US 2001/0046029 A1
(43) Pub. Date: Nov. 29, 2001

(54) Spectacle frame with auxiliary frame of magnetically attractable material

(76) Inventors: Domenic Miele, Harrison, NY (US); Joseph Lanzillotti, Harrison, NY (US)

Correspondence Address: Charles E. Temko, 22 Marion Road, Westport, CT, 06880, US

(21) Appl. No.: 09/782,228

(22) Filed: Feb. 14, 2001

Related U.S. Application Data
(60) Provisional application No. 60/183,975, filed on Feb. 22, 2000.

(51) Int. Cl. G02C 7/08; G02C 9/02; G02C 5/14

(52) U.S. Cl. 351/57; 351/59; 351/116

(57) ABSTRACT

A combination spectacle frame with selectively attachable auxiliary frame. The spectacle frame carries a pair of socket-forming members having recessed magnets. The auxiliary frame is formed of non-magnetic magnetically attractive material, and includes a pair of corresponding projections which are engaged within the recesses by the magnets on the spectacle frame.

### BACKGROUND OF THE INVENTION

This invention relates generally to the field of spectacle frames, and more particularly to an improved combination frame including a principal frame which supports corrective lenses, and an auxiliary frame selectively engageable with the principal frame which supports sunglass lenses or other eye protective media. Devices of this general type are known in the art, and the invention lies in improved constructional details which afford increased facility in manufacture, as well as ease of use by certain users.

In the prior art it is common to provide a pair of magnets on the principal frame which are seated in recesses in supporting members on the principal frame. The auxiliary frame is provided with corresponding members having a pair of projections having a second pair of magnets of opposite polarity, so that when the auxiliary frame is correctly positioned upon the principal frame, the two frames will be detachably interconnected in non-slip relation.

One of the problems of increasing importance in recent years is the use of electro-mechanical heart pacemakers and similar devices which are surgically implanted in the body of the user in the area of the heart. These devices are particularly sensitive to radiant energy, and in the case of radiant electromagnetic energy located in the area of the pacemaker, the proper functioning of the pacemaker may be affected. It is common practice to carry to auxiliary spectacle frame of the combination in the breast pocket of a garment worn by the user to result in the positioning of the magnets on the auxiliary frame in relatively close location relative to the pacemaker.

### SUMMARY OF THE INVENTION

Briefly stated, the invention contemplates the provision of an improved combination spectacle frame of the class described in which the above-described problem has been eliminated. To this end, the magnets previously mounted on the auxiliary frame have been eliminated to be replaced by non-magnetic members, which are capable of being magnetically attracted by the magnets on the principal frame, but retain no magnetic charge when the auxiliary frame is in disengaged condition. A typically suitable material is cast iron, although other non-magnetic materials such as stainless steel, nickel alloys and the like also may be used.

### BRIEF DESCRIPTION OF THE DRAWINGS

In the drawings, to which reference will be made in the specification, similar reference characters have been employed to designate corresponding parts throughout the several views.

FIG. 1 is a front elevational view of a primary spectacle frame element in accordance with the invention.

FIG. 2 is a front elevational view of a corresponding auxiliary frame element.

FIG. 3 is a top plan view of the primary frame element.

FIG. 4 is a top plan view of the auxiliary frame element.

FIG. 5 is an enlarged sectional view showing non-magnetic means comprising part of the auxiliary frame element.

FIG. 6 is an enlarged sectional view showing corresponding magnetic means on the primary frame element.

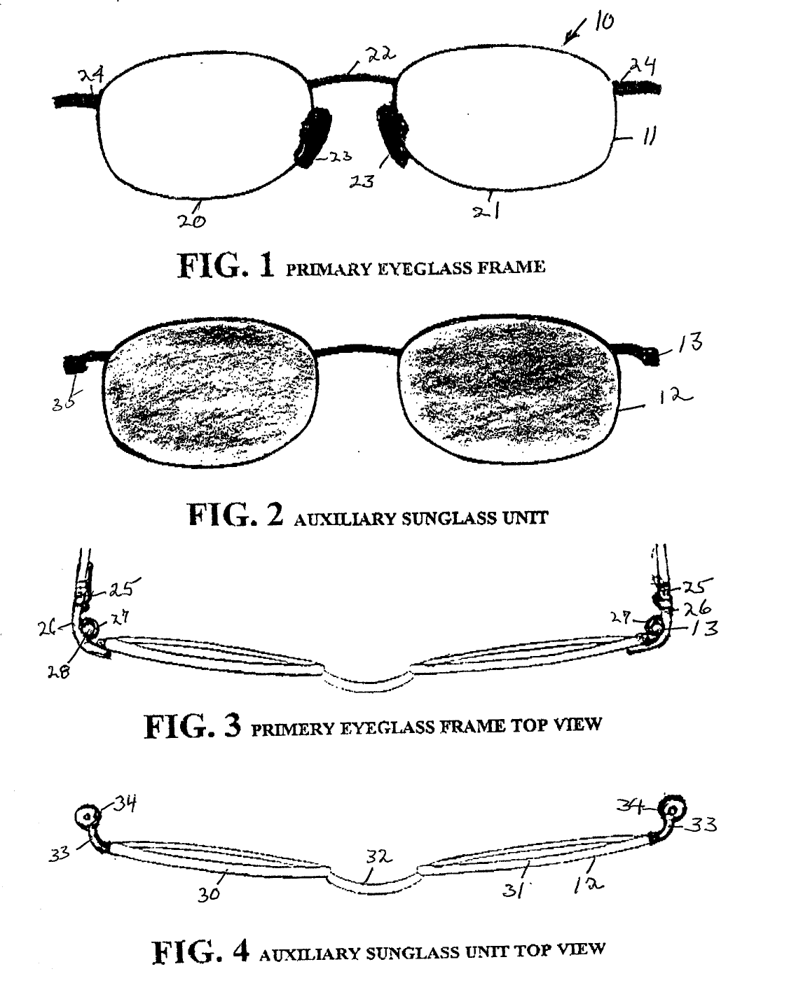

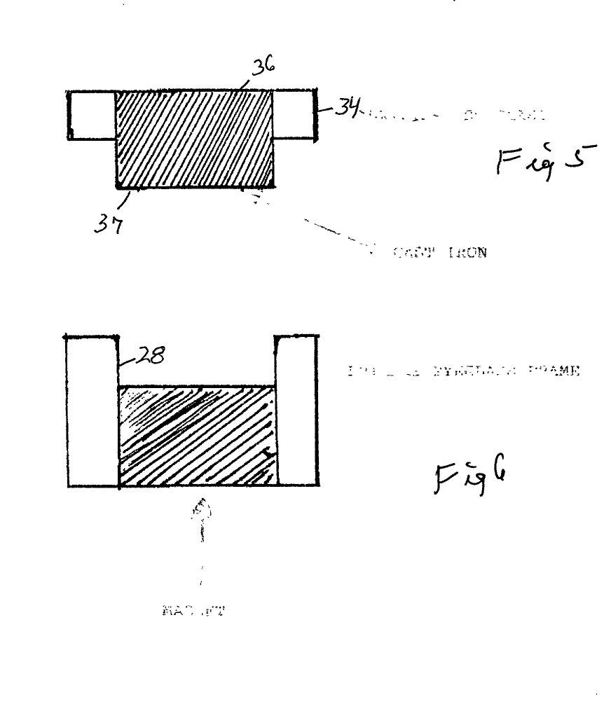

### DETAILED DESCRIPTION OF THE DISCLOSED EMBODIMENT

In accordance with the invention, the device, generally indicated by reference character 10, comprises a primary spectacle frame element 11, an auxiliary spectacle frame element 12 and interconnecting means 13.

The primary spectacle frame element is generally conventional, including first and second lens-retaining members 20 and 21, an interconnecting bridge 22, nose pads 23 and temple members 24 mounting hinges 25 on a temple extension 26 for having socket-forming members 27. The members 27 include a bore 28 supporting a polarized magnet at one end thereof.

The auxiliary frame element 12 is also generally conventional, including first and second lens-retaining members 30 and 31, a bridge 32, and temple extension members 33 having a free terminal 34 defining a bore 35 having a non-metallic insert 36 including a projecting portion 37 adapted to engage the bore 28 for selective engagement of the auxiliary frame element. Typically, the non-metallic insert 36 is formed of cast iron, but may be substituted by other metallic, non-magnetic materials such as stainless steel, nickel alloys, and the like. Although these materials are readily attracted to a magnet, upon disconnection, they do not retain a magnetic charge thereafter. As a result, there is no electromagnetic radiation from the auxiliary spectacle frame when it is located in the area of a pacemaker or other implanted device carried by the user.

We wish it to be understood that we do not consider the invention to be limited to the precise details of structure shown and described in the specification, for obvious modifications will occur to those skilled in the art to which the invention pertains:

We claim:

1. In a combination spectacle frame construction including a principal frame element and an auxiliary frame element, said frame elements each having means at a pair of extensions in the temporal area on each frame element for selective magnetic interconnection, the improvement comprising: one of said frame elements defining a socket, the other of said frame elements defining a projection selectively engageable with said socket; a magnet positioned within a closed end of said socket, said projection being formed of non-magnetic, magnetically attractable material.

2. The improvement in accordance with claim 1, in which said principal and auxiliary frame elements have socket-forming and socket-engaging projection means at each temporal end thereof.

3. The improvement in accordance with claim 2, in which said projections are formed on said auxiliary frame element.

4. The improvement in accordance with claim 1, in which said projection is formed of case iron.

5. The improvement in accordance with claim 1, in which said projection is formed of metallic material having a ferrous content.
